(19) United States
(12) Patent Application Publication
(10) Pub. No.: US 2021/0031718 A1
(43) Pub. Date: Feb. 4, 2021

(54) OVERHEAD AIRBAG WITH LEG INTERACTION CHAMBER

(71) Applicant: GM Global Technology Operations LLC, Detroit, MI (US)

(72) Inventors: Jeffrey J. Schultz, Grand Blanc, MI (US); Scott D. Thomas, Novi, MI (US)

(21) Appl. No.: 16/526,351

(22) Filed: Jul. 30, 2019

(51) Int. Cl. B60R 21/231; B60R 21/213

(52) U.S. Cl. CPC B60R 21/231; B60R 2021/161; B60R 21/213

(57) ABSTRACT

An automobile vehicle airbag assembly includes an airbag body connected to and extending when inflated downward from an overhead vehicle portion. A cushion extending from the airbag body has a first portion which when inflated positioned directly in front of an occupant. A second portion when inflated extends from the first portion and has a lower end aligned to interact with legs of the occupant to limit rotational motion of a lower leg portion of the legs to prevent hyper-extension of at least one knee of the occupant.

The present disclosure relates to automobile vehicle airbags and airbag systems.

Automobile vehicles commonly include at least one airbag which automatically inflates when a sensor such as an accelerometer signals a rapid deceleration or acceleration of the vehicle which occurs and exceeds a predetermined threshold. Airbags are positioned in a steering wheel in front of an occupant such as a vehicle driver, in a vehicle dashboard in front of one or more occupants such as vehicle passengers, on the sides of seats and in outboard vehicle overhead trim locations known as “curtain” airbags. In addition one or more airbags can be located in the middle portion of the overhead trim and deploy downward, react a motion of the operators or passengers of the vehicle toward these airbags.

An airbag positioned in the vehicle overhead which substitutes for the steering wheel airbag or dashboard airbag inflates downwardly to project the airbag in front of the occupant such as a driver or passenger. The overhead airbag therefore provides a head reaction surface and possibly a torso restraint reaction surface. This airbag will not extend below the waist level of the driver or passenger and will therefore not react the motion of the driver's or passenger's legs. Depending on crash severity, hyperextension of the occupant's legs and in particular the knees may occur following airbag deployment as the occupant's legs may swing upward.

Thus, while current vehicle airbags achieve their intended purpose, there is a need for a new and improved system and method for preventing hyperextension of an occupant's legs and knees when an overhead airbag is deployed.

### SUMMARY

According to several aspects, an automobile vehicle airbag assembly includes an airbag body connected to and extending downward when inflated from an overhead vehicle portion. A first cushion extends from the airbag body. The first cushion includes a first portion that once inflated positions directly in front of an occupant; and a second portion that when inflated interacts with the legs of the occupant to limit rotational motion of a lower leg portion of the legs of the occupant to prevent hyper-extension of at least one knee of the occupant.

In another aspect of the present disclosure, the second portion interacting with the legs of the occupant is wider than the first portion.

In another aspect of the present disclosure, a second cushion has a first portion when inflated positioned directly in front of and contacted by the occupant and a second portion when inflated interacting with the legs of the occupant.

In another aspect of the present disclosure, the second portion of the first cushion laterally overlaps the second portion of the second cushion.

In another aspect of the present disclosure, the second portion of the first cushion directly abuts the second portion of the second cushion.

In another aspect of the present disclosure, the first portion is positioned to be contacted by at least one of a face and a torso of the occupant.

In another aspect of the present disclosure, the second portion is mechanically attached to the first portion of the cushion by a sewn connection.

In another aspect of the present disclosure, the second portion is attached to the first portion of the cushion by a woven connection.

In another aspect of the present disclosure, the second portion tapers from a first cross-section where the second portion attaches to the first portion of the cushion to a second cross section narrower than the first cross section where the second portion contacts the legs of the occupant.

In another aspect of the present disclosure, a support tether connects the second portion to at least one location on the first portion.

In another aspect of the present disclosure, an internal lateral tether positioned within the second portion to control a width of the second portion.

In another aspect of the present disclosure, the second portion includes an inflated perimeter and an un-inflated section defining a cavity.

In another aspect of the present disclosure, an axis of the second portion when inflated is oriented vertically.

In another aspect of the present disclosure, an axis of the second portion when inflated is angularly oriented with respect to a vehicle orientation.

In another aspect of the present disclosure, the second portion contains at least one shaping tether extending between and fixed to opposed walls of the second portion within a throat of the second portion to control a shape of the second portion.

According to several aspects, an automobile vehicle airbag assembly includes an airbag body connected to and extending when inflated downward from an overhead vehicle portion. A cushion extending from the airbag body includes a first portion when inflated positioned directly in front of an occupant. The first portion includes at least one of a first surface segment aligned to be contacted by a chest of the occupant, and a second surface segment aligned to be contacted by a head of the occupant. A second portion extending downward from the cushion which when inflated has a lower end aligned to interact with legs of the occupant to limit rotational motion of a lower leg portion of the legs to prevent hyper-extension of at least one knee of the occupant.

In another aspect of the present disclosure, the first portion is in communication with the second portion. At least one gas pass through-hole is present between the second portion and the first portion to enable inflator gas in the first portion to enter the second portion; and opposed side panels.

In another aspect of the present disclosure, at least one of a first tether connects the first portion to the cushion and a second tether connects the second portion to the cushion.

According to several aspects, an automobile vehicle airbag assembly includes an airbag body connected to an overhead vehicle portion and extending downward when inflated from the overhead vehicle portion. A cushion extending from the airbag body includes a first portion that when inflated is positioned directly in front of an occupant. The first portion arranged so that the first portion contacts at least one of a head and a chest of the occupant. A second portion extending downward from the cushion that when inflated interacts with legs of the occupant to limit rotational motion of a lower leg portion of the legs to prevent hyper-extension of a knee of the occupant, the second portion including an arm fixed to the first portion and a branch fixed at an end of the arm.

In another aspect of the present disclosure, the branch includes a first end and an oppositely directed second end extending outwardly from the arm; and wherein a length of the branch is greater than a width of the arm.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side elevational view of an automobile vehicle airbag system according to an exemplary aspect;

FIG. 2 is a side elevational view of another aspect of an automobile vehicle airbag system;

FIG. 3 is a side elevational view of a further aspect of an automobile vehicle airbag system;

FIG. 4 is a front right perspective view of another aspect of an automobile vehicle airbag system;

FIG. 5 is a partial cross-sectional perspective view taken at section 5 of FIG. 4;

FIG. 6 is a front right perspective view of another aspect of an automobile vehicle airbag system;

FIG. 7 a side elevational view of another aspect of an automobile vehicle airbag system; and

FIG. 8 is a front right perspective view of another aspect of an automobile vehicle airbag system.

### DETAILED DESCRIPTION

The following description is merely exemplary in nature and is not intended to limit the present disclosure, application, or uses.

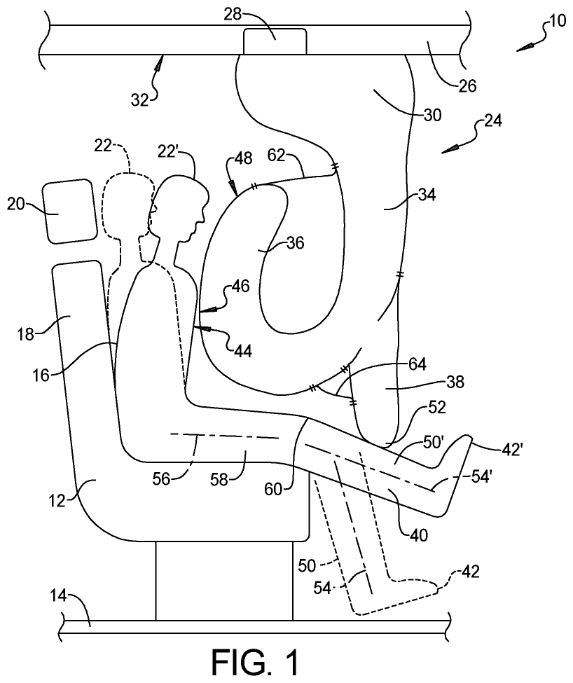

Referring to FIG. 1, an automobile vehicle airbag system 10 is positioned in front of a vehicle seat 12 mounted in an automobile vehicle 14. An occupant 16 of the vehicle 14 in a seated position in the vehicle seat 12 contacts a seat back 18 and a head restraint 20. During a rapid deceleration event, a head of the occupant 16 moves from a normal resting head position 22 shown in phantom to a forward displaced head position 22′. To react the forward motion of the occupant 16 during the rapid deceleration event an airbag assembly 24 is inflated and extends downwardly from a vehicle ceiling 26 from a stored position in an airbag module 28 positioned in the vehicle ceiling 26. The module 28 includes an inflator, a folded cushion, a deployment door and module-to-vehicle structure mounting provisions (not shown) which are typical to module constructions for other airbag locations such as steering wheel mounted driver airbags and instrument panel mounted passenger airbags and the like.

The airbag assembly 24 includes a body 30 shown in an inflated condition extended downward away from a roof liner 32. The body 30 includes a cushion 34 having one or more portions contacted by the occupant 16. According to several aspects, the cushion 34 includes a first portion 36 defining a body reaction portion which when inflated forms a U-shape or curved-shape directed toward the occupant 16 and a second portion 38 defining a leg reaction portion which when inflated extends downward from the cushion 34 and is contacted by legs 40 (only one leg is shown in this view) of the occupant 16 as the feet of the occupant 16 displace from a normal downward foot position 42 to a forward extended foot position 42′ due to rapid deceleration of the vehicle 14. According to several aspects, an axis of the second portion 38 when inflated is oriented vertically. The first portion 36 is located between the mounting location of the vehicle ceiling 26 and the second portion 38. The first portion 36 may also extend to the occupant 16 contact portion where contact may be made with the head 22′ or a chest 44 of the occupant 16.

As illustrated in FIG. 1, as the occupant 16 displaces forward the chest 44 of the occupant 16 contacts a first surface segment 46 of the first portion 36, and the head at the forward displaced head position 22′ contacts a second surface segment 48 of the first portion 36. As the legs 40 displace from the normal resting or downward foot position 42 to the forward extended foot position 42′ a lower leg rotates from a lower leg normal resting position 50 to a lower leg rotated position 50′ and contacts a lower end 52 of the second portion 38 of the cushion 34.

During normal vehicle operation an axis 54 of the lower leg normal resting position 50 is oriented at an angle ranging from approximately 90 degrees up to approximately 120 degrees with respect to an axis 56 of a thigh 58 of the legs. During the rapid deceleration event the lower leg rotates with respect to a knee 60 from the lower leg normal resting position 50 to the lower leg rotated position 50′ which repositions the axis 54 to an axis rotated position 54′. To prevent hyper-extension of the knee 60 it is undesirable to allow the axis rotated position 54′ to reach and exceed beyond a biometric based amount, such as a position which is co-linear with the axis 56 of the thigh 58. A length of the second portion 38 which establishes the position of the lower end 52 of the second portion 38 is therefore predetermined so the lower leg contacts the lower end 52 prior to the axis rotated position 54′ reaching and exceeding beyond the biometric based amount, such as the position which is co-linear with the axis 56 of the thigh 58.

To retain an inflated shape of the airbag assembly 24 a first tether 62 can be connected between the first portion 36 and the cushion 34. Similarly, a second tether 64 can be connected between the first portion 36 and the second portion 38.

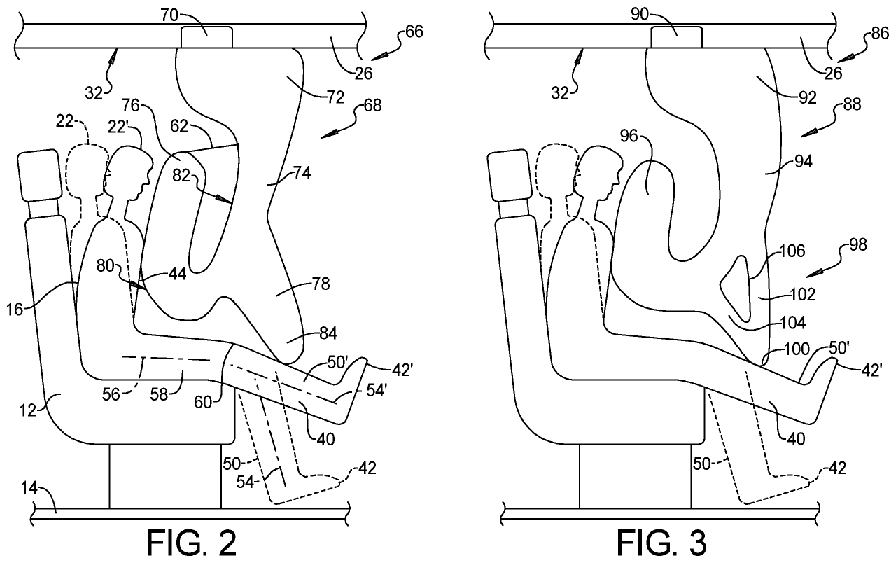

Referring to FIG. 2 and again to FIG. 1, an automobile vehicle airbag system 66 is modified from the automobile vehicle airbag system 10 with common components numbered the same. To react the forward motion of the occupant 16 during the rapid deceleration event an airbag assembly 68 is inflated and extends downwardly from the vehicle ceiling 26 from a stored position in an airbag module 70 positioned in the vehicle ceiling 26.

The airbag assembly 68 includes a body 72 shown in an inflated condition extended downward away from the roof liner 32. The body 72 includes a cushion 74 having one or more portions contacted by the occupant 16. According to several aspects, the cushion 74 includes a first portion 76 defining a body reaction portion which when inflated curves from the body 72 downwardly, rearwardly and then upwardly toward the occupant 16 and a second portion 78 defining a leg reaction portion which when inflated extends downward from the cushion 74 at an angle and can be contacted by the legs 40 (only one leg is shown in this view) of the occupant 16 as the feet of the occupant 16 displace from a normal downward foot position 42 to a forward extended foot position 42′ due to rapid deceleration of the vehicle 14.

As the occupant 16 displaces forward the chest 44 of the occupant 16 contacts a first surface segment 80 of the first portion 76, and the head at the forward displaced head position 22′ contacts a second surface segment 82 of the first portion 76. As the legs 40 displace from the normal resting or downward foot position 42 to the forward extended foot position 42′ a lower leg rotates from the lower leg normal leg resting position 50 to the lower leg rotated position 50′ and contacts a lower end 84 of the second portion 78 of the cushion 74.

According to one aspect, the cushion 74 is modified from the cushion 34. The second portion 78 when inflated is angularly oriented with respect to the first portion 76.

Referring to FIG. 3 and again to FIGS. 1 and 2, an automobile vehicle airbag system 86 is modified from the automobile vehicle airbag systems 66 and 10 with common components numbered the same. To react the forward motion of the occupant 16 during the rapid deceleration event an airbag assembly 88 is inflated and extends downwardly from the vehicle ceiling 26 from a stored position in an airbag module 90 positioned in the vehicle ceiling 26.

The airbag assembly 88 includes a body 92 shown in an inflated condition extended downward away from the roof liner 32. The body 92 includes a cushion 94 having one or more portions contacted by the occupant 16. According to several aspects, the cushion 94 includes a first portion 96 which is similar to the first portion 76 defining a body reaction portion which when inflated curves from the body 92 downwardly, rearwardly and then upwardly toward the occupant 16 and a second portion 98 defining a leg reaction portion which when inflated extends downward from the cushion 94 at an angle and is contacted by the legs 40 (only one leg is shown in this view) of the occupant 16 as the feet of the occupant 16 displace from the normal resting or downward foot position 42 to the forward extended foot position 42′ due to rapid deceleration of the vehicle 14.

As the legs 40 displace from the normal resting or downward foot position 42 to the forward extended foot position 42′ the lower leg rotates from the lower leg normal leg resting position 50 to the lower leg rotated position 50′ and contacts a lower end 100 of the second portion 98 of the cushion 94.

According to several aspects the cushion 94 is modified from the cushion 74 with the second portion 98 divided into a first segment 102 and a second segment 104 separated by an open through cavity 106. The second portion 98 therefore includes an inflated perimeter defined by the first segment 102 and the second segment 104 and an un-inflated middle section defined by the cavity 106. The provision of the cavity 106 provides several benefits. The cavity 106 reduces a total volume of gas required to fill the second portion 98 compared to the second portion 78 while the second segment 104 obviates the need for the second tether 64 used for the airbag assembly 24 described in reference to FIG. 1. Tethers within the first segment 102 and within the second segment 104 and within the body 92 (not shown) may be used to shape these cushion portions to maintain the cavity 106 opening and shape.

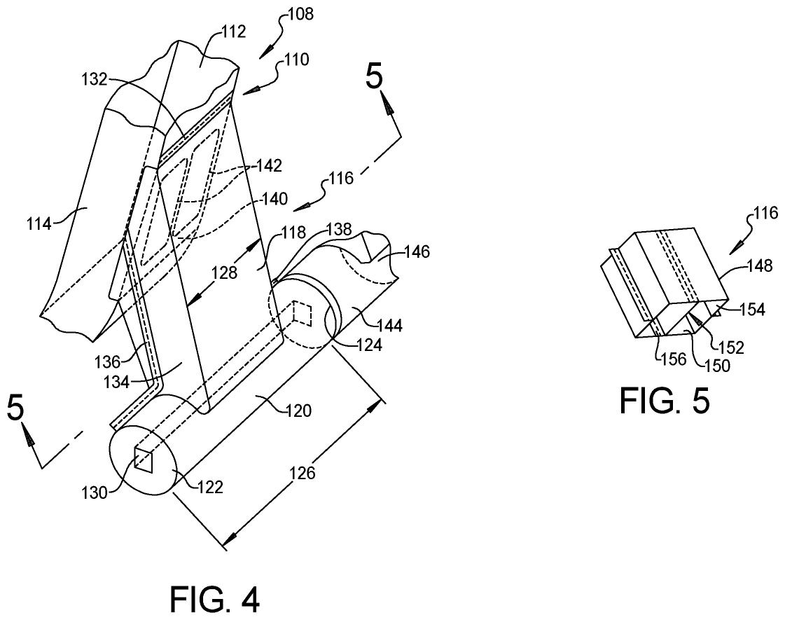

Referring to FIG. 4 and again to FIGS. 1, 2 and 3, an automobile vehicle airbag system 108 is modified from the automobile vehicle airbag systems 86, 66 and 10. The airbag system 108 includes a body 110 shown in an inflated condition extended downward away from the roof liner (not shown in this view). The body 110 includes a cushion 112 having a first portion 114 contacted by at least one of the head and chest of the occupant 16. The cushion 112 also includes a second portion 116 defining a leg reaction portion which when inflated extends downward from the first portion 114 of the cushion 112 and forward of the first portion 114.

The second portion 116 includes an arm 118 fixed to the first portion 114 and a cylindrical-shaped laterally extending branch 120 at a lower end of the arm 118. According to several aspects, the branch 120 includes a first end 122 and an oppositely directed second end 124 which extend outwardly from the arm 118. A length 126 of the branch 120 is therefore greater than a width 128 of the arm 118. The second portion 116 at the branch 120 which interacts with the legs of the occupant is therefore wider than the first portion 114. The branch 120 is contacted by the legs 40 (not shown in this view) of the occupant as the feet of the occupant displace from the normal downward foot position 42 to the forward extended foot position 42′ due to rapid deceleration of the vehicle 14 shown and described in reference to FIGS. 1 through 3.

A sewn in or otherwise mechanically attached lateral internal tether 130 may be included within and extend throughout the length 126 of the branch 120 to control the length 126 of the branch 120. The second portion 116 is mechanically attached to the first portion 114 of the cushion 112, for example by a seam 132 which can be a sewn connection or a woven connection. The second portion 116 also includes opposed side panels 134 only one of which is clearly visible in this view. The second portion 116 also has perimeter seams 136, 138 to help form the construction from fabric panels. Likewise, the first end 122 and the second end 124 can be attached with end perimeter seams (not shown). An inner wall 140 connecting the second portion 116 to the first portion 114 can include one or more apertures 142 which allow gas flow during fill. A first end 144 of an adjacent second cushion 146 (only partially shown for clarity) abuts the second end 124 therefore according to several aspects the second portion 116 of the cushion 112 defining a first cushion directly abuts a second portion of the cushion defining the second cushion 146. This abutment occurs with the branch portions.

Referring to FIG. 5 and again to FIGS. 1 through 4, a section of the second portion 116 is shown. An outer wall 148 is spatially separated from an inner wall 150, with at least one shaping tether 152 spanning between and fixed to the outer wall 148 and the inner wall 150 of a throat 154 of the second portion 116. The shaping tether 152 is provided to control a shape of the second portion 116 to prevent the second portion 116 from filling in a spherical shape and may be installed using at least one longitudinal seam 156.

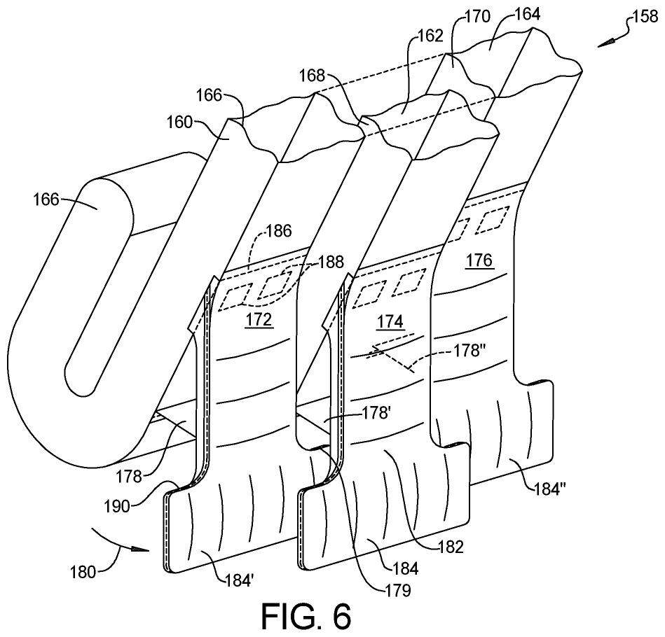

Referring to FIG. 6 and again to FIGS. 1 through 4, an automobile vehicle airbag system 158 is modified from the automobile vehicle airbag systems 108, 86, 66 and 10. The airbag system 158 includes three bodies positioned in a sequential order including a first body 160, a second body 162 and a third body 164. The three bodies are shown in an inflated condition extended downward away from the roof liner (not shown in this view). The three bodies individually act as a first portion 166, 168, 170 similar to the first portions 36, 76, 96, 114 discussed in reference to FIGS. 1 through 4 and may be contacted by either the head or chest of the occupant 16 and therefore individually define a body reaction portion which when inflated curves downwardly, rearwardly and upwardly toward the occupant 16.

The first body 160, the second body 162 and the third body 164 also individually include a second portion 172, 174, 176 respectively. The second portions 172, 174, 176 individually define a leg reaction portion which when inflated extends downward from the first portions 166, 168, 170 and forward of the first portions 166, 168, 170. A mechanical attachment which can be a tether such as an exemplary tether 178, 178′, with a third tether 178″ only partially visible in this view, connects one of the second portions 172, 174, 176 to one of the first portions 166, 168, 170 and allows the second portions 172, 174, 176 to displace away from the first portions 166, 168, 170 in a displacement direction 180 within a fixed spacing provided by a predetermined length of the tether 178, 178′, 178″. The second portions 172, 174, 176 individually include an inflated arm 182 similar to the arm 118 described in reference to FIG. 4 and an inflated branch 184, 184′, 184″ which functions similar to the branch 120 described in reference to FIG. 4. According to several aspects, the construction of the inflated arm 184, 184′, 184″ and the inflated branch 184, 184′, 184″ may be made from a single piece of fabric that is attached with seams 190 as illustrated for the first body 160, in lieu of the multi-piece construction of branch 120.

With continuing reference to FIG. 6, according to several aspects, the second body 162 is disposed further forward compared to the first body 160 and the third body 164. This disposition aligns the branch 184 of the second portion 174 to overlap both the branch 184′ of the second portion 172 and the branch 184″ of the second portion 176, therefore the second portion of one of the cushions laterally overlaps the second portion of at least another one of the cushions. Overlapping the second portions ensures that the legs of second, third or more occupants who are seated next to each other are restrained by at least one of the second portions. In the manner illustrated in FIG. 6, the second portions 172, 174, 176 may be the same shape and the first portions 166, 168, 170 may be different shapes to account for the offset at the top of the bodies 160, 162, 164.

As illustrated for the first body 166 and the second portion 172 an inner wall 186 connecting the second portions 172, 174, 176 to the bodies 160, 162, 164 can include one or more apertures 188 which allow gas flow during cushion fill similar to apertures 142 described in reference to FIG. 4.

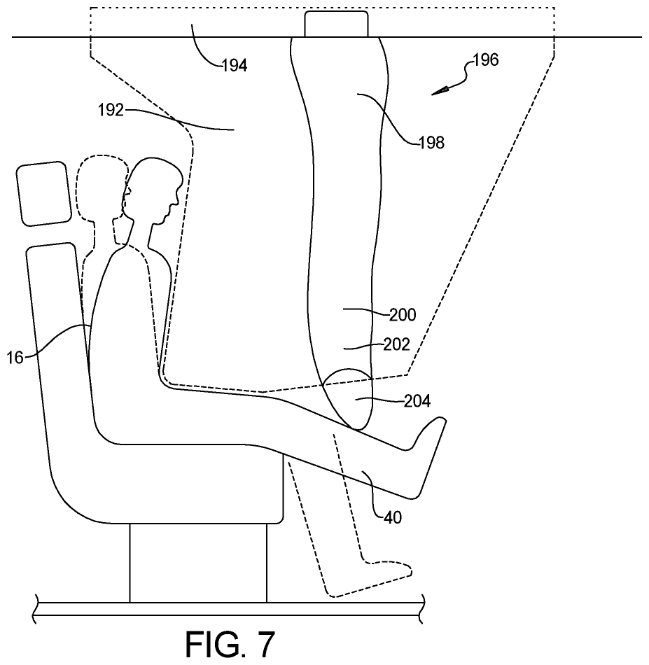

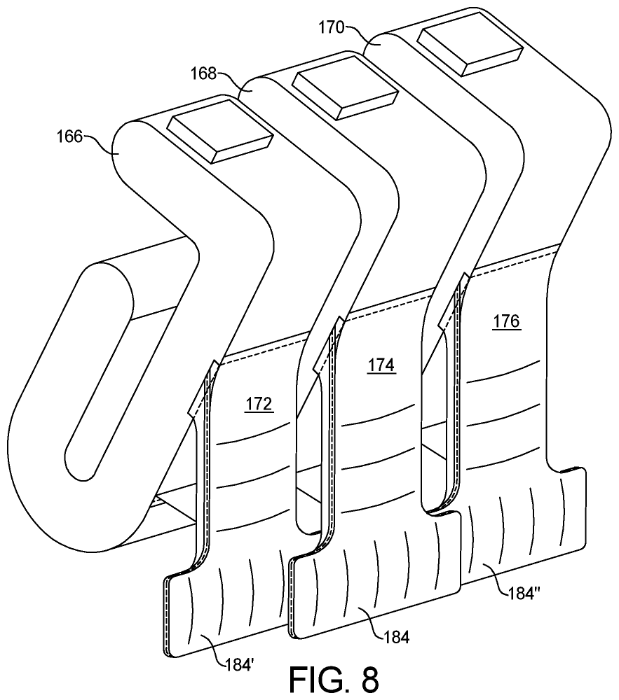

Referring to FIG. 7 and again to FIGS. 1 through 6, the bodies of the airbag systems 10, 66, 86, 108, 158 can have many different shapes as illustrated by a cushion zone 192 that extends forward of and over the occupant 16. The shapes can have different size cross-sections in different locations and can be shapes other than the “J” shape that can be seen in the view of FIGS. 1, 2, 3 and 6. The bodies may interact with either the head or the chest of the occupant. In addition, the modules such as the module 28 can be located in a module zone 194 identified using a dotted line perimeter. A body 196 can include a first portion 198 that does not interact with the occupant 16 and a second portion 200 that interacts with the legs 40 of the occupant 16. The second portion 200 can further include an arm 202 and a branch 204.

Referring to FIG. 8 and again to FIGS. 1 through 7, according to an alternative aspect, the first second and third bodies 162, 164, 166 may be aligned and the second portions 172, 174, 176 may be shaped so that the branches 184′, 184, 184″ of the second portions 172, 174, 176 overlap laterally. In this manner the second portions 172, 174, 176 have different shapes and the body portions may have the same shape.

According to further aspects and with further reference to FIG. 6, the first body 160, the second body 162 and the third body 164 can be part of a same airbag module or can be separate adjacently located airbag modules. If the first body 160, the second body 162 and the third body 164 are part of a same airbag module one or more inflators can be used to fill the first body 160, the second body 162 and the third body 164. Any number of bodies can be used inside a vehicle having an automobile vehicle airbag system of the present disclosure.

According to several aspects, the automobile vehicle airbag systems of the present disclosure include an airbag body connected to and extending downward when inflated from an overhead vehicle portion. A cushion extends from the airbag body. The cushion includes: a first portion which when inflated is positioned directly in front of and may be contacted by an occupant; and a second portion which when inflated interacts with the legs of the occupant to restrict rotational motion of a lower leg portion of the legs of the occupant thereby preventing hyper-extension of a knee of the occupant.

According to several aspects the cushion is laterally narrower in the first portion where a face and a torso of the occupant contact the cushion and laterally wider in the second portion where the legs of the occupant contact the cushion.

An automobile vehicle airbag system of the present disclosure offers several advantages. These include providing an overhead airbag with a leg interaction chamber for restraining occupant legs so that the occupant does not experience knee hyper-extension related issues during higher severity crash events with air-bag deployment.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An automobile vehicle airbag assembly, comprising:
an airbag body connected to and extending downward when inflated from an overhead vehicle portion; and
a first cushion extending from the airbag body, having:
a first portion that once inflated positions directly in front of an occupant; and
a second portion that when inflated interacts with legs of the occupant to limit rotational motion of a lower leg portion of the legs of the occupant to prevent hyper-extension of at least one knee of the occupant.

2. The automobile vehicle airbag assembly of claim 1, wherein the second portion interacting with the legs of the occupant is wider than the first portion.

3. The automobile vehicle airbag assembly of claim 2, further including a second cushion having a second cushion first portion when inflated positioned directly in front of and contacted by a second occupant and a second cushion second portion when inflated interacting with legs of the second occupant.

4. The automobile vehicle airbag assembly of claim 3, wherein the second portion of the first cushion laterally overlaps the second portion of the second cushion.

5. The automobile vehicle airbag assembly of claim 3, wherein the second portion of the first cushion directly abuts the second portion of the second cushion.

6. The automobile vehicle airbag assembly of claim 1, wherein the first portion is positioned to be contacted by at least one of a face and a torso of the occupant.

7. The automobile vehicle airbag assembly of claim 1, wherein the second portion is mechanically attached to the first portion of the first cushion by a sewn connection.

8. The automobile vehicle airbag assembly of claim 1, wherein the second portion is attached to the first portion of the first cushion by a woven connection.

9. The automobile vehicle airbag assembly of claim 1, wherein the second portion tapers from a first cross-section where the second portion attaches to the first portion of the first cushion to a second cross section narrower than the first cross-section where the second portion contacts the legs of the occupant.

10. The automobile vehicle airbag assembly of claim 1, further including a support tether connecting the second portion to at least one location on the first portion.

11. The automobile vehicle airbag assembly of claim 1, further including an internal lateral tether positioned within the second portion to control a width of the second portion.

12. The automobile vehicle airbag assembly of claim 1, wherein the second portion includes an inflated perimeter and an un-inflated section defining a cavity.

13. The automobile vehicle airbag assembly of claim 1, wherein an axis of the second portion when inflated is oriented vertically.

14. The automobile vehicle airbag assembly of claim 1, wherein an axis of the second portion when inflated is angularly oriented with respect to a vehicle orientation.

15. The automobile vehicle airbag assembly of claim 1 wherein the second portion contains at least one shaping tether extending between and fixed to opposed walls of the second portion within a throat of the second portion to control a shape of the second portion.

16. An automobile vehicle airbag assembly, comprising:
an airbag body connected to and extending when inflated downward from an overhead vehicle portion; and
a cushion extending from the airbag body, having:
a first portion when inflated positioned directly in front of an occupant, the first portion having at least one of a first surface segment aligned to be contacted by a chest of the occupant and a second surface segment aligned to be contacted by a head of the occupant; and
a second portion extending downward from the cushion which when inflated has a lower end aligned to interact with legs of the occupant to limit rotational motion of a lower leg portion of the legs to prevent hyper-extension of at least one knee of the occupant.

17. The automobile vehicle airbag assembly of claim 16, wherein:
the first portion in communication with the second portion; and
at least one gas pass through-hole is present between the second portion and the first portion to enable inflator gas in the first portion to enter the second portion; and opposed side panels.

18. The automobile vehicle airbag assembly of claim 16, further including at least one of a first tether connecting the first portion to the cushion and a second tether connecting the second portion to the cushion.

19. An automobile vehicle airbag assembly, comprising:
an airbag body connected to an overhead vehicle portion and extending downward when inflated from the overhead vehicle portion; and
a cushion extending from the airbag body, having:
a first portion that when inflated is positioned directly in front of an occupant, the first portion arranged so that the first portion contacts at least one of a head and a chest of the occupant; and
a second portion extending downward from the cushion that when inflated interacts with legs of the occupant to limit rotational motion of a lower leg portion of the legs to prevent hyper-extension of a knee of the occupant, the second portion including an arm fixed to the first portion and a branch fixed at an end of the arm.

20. The automobile vehicle airbag assembly of claim 19, wherein the branch includes a first end and an oppositely directed second end extending outwardly from the arm; and wherein a length of the branch is greater than a width of the arm.
